(19) United States
(12) Patent Application Publication
(10) Pub. No.: US 2014/0069337 A1
(43) Pub. Date: Mar. 13, 2014

(54) Dog Mat

(71) Applicant: Edwin Dunford, Vero Beach, FL (US)

(72) Inventor: Edwin Dunford, Vero Beach, FL (US)

(21) Appl. No.: 14/023,167

(22) Filed: Sep. 10, 2013

Related U.S. Application Data
(60) Provisional application No. 61/698,853, filed on Sep. 10, 2012.

(51) Int. Cl. A01K 1/035

(52) U.S. Cl. CPC A01K 1/0353
USPC 119/28.5

(57) ABSTRACT

An improved dog mat made of closed cell, cross linked polyolefin elastomeric or ethylene vinyl acetate (EVA) foam with a continuous, soft outer surface impervious to water, chemicals, and pathogens and scratch and tear resistant. The mat is a thin planar structure designed to be used on the flat surface, such as the floor of a building or inside a kennel. The mat includes a first planar surface with texture elements, such as raised, diamond shaped elements, flat vertical side walls and a smooth, second planar surface parallel to the first planar surface. Formed along the perimeter edge of the first planar surface is a continuous raised lip. The mat may be rectangular, square, triangular, circular, oval or oblong. The mat is also sufficiently flexible so it may be rolled into a compact cylindrical tube for compact storage.

This utility patent application is based upon and claims the filing date benefit of U.S. provisional patent application (Application No. 61/698,853) filed on Sep. 10, 2012.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

This invention pertains to animal mats used to protect floors, seats, and furniture from dirt, mud and water carried by the fur of the animal, and more to improved mats used by dogs that more durable, and are non-absorbent to water, dirt, and pathogens, and can be easily cleaned.

2. Description of the Related Art

Many dogs spend significant time outdoors where they become dirty and wet. When the dogs are brought indoors, the dirt and water deposited on their furs are deposited on the floors, walls and furniture inside the building.

When a mat or rug is placed on the floor for use by a dog, it is important that the mat or rug have a lower contact surface that resists sliding movement and keeps the mat or rug in the designated area. It is also important that any water and dirt that falls onto the mat remains on the top surface of the mat and does not drip or seep onto the floor.

When traveling in a motor vehicle, dogs are often transported in a cage-like kennel setup inside the vehicle or in the cargo region that restrains the dog to the motor vehicle. When initially placed into the kennel, the dog is normally clean and dry. When the destination is reached, and the dog is released outdoors, the dog becomes dirty and/or wet which can be problematic when the dirty and wet dog is placed back into the kennel and transported back home.

Many dog owners place a floor mat or rug in the kennel to provide comfort to the dog and to capture any dirt particles or water drops that may fall off the dog. The mat and rug are made of absorbent materials and mildew and dirt becomes imbedded. Because these mats and rugs are made of fibrous material, some dogs regarded them as chewy toys and destroy them in a few hours.

What is needed is a durable mat with skid resistance surfaces, that can be used in an open floor area or inside a dog kennel, that does not absorb water and dirt, that can be easily cleaned with soap and water, and is chew and tear resistant.

### SUMMARY OF THE INVENTION

The above needs are met by the dog mat disclosed that is made of thin soft foam material impervious to water, chemicals, pathogens, scratch and tear resistant, and UV resistant.

The dog mat is made of closed cell, cross linked polyolefin elastomeric or ethylene vinyl acetate (EVA) foam using injection molding processes. The mat is made of a single later of foam with a continuous, soft outer surface impervious to water, chemicals, and pathogens and scratch and tear resistant. The mat is a wide, planar structure designed to be used on the flat surface, such as the floor of a building or home or inside a kennel. The mat includes a first planar surface with texture elements, such as a plurality of diamond-shaped raised elements that simulate a metal diamond plate surface, a smooth second surface opposite the first planar surface and four vertical side surfaces. After molding, the outer surface of the foam is uniform and continuous cover the planar and side surfaces thereby preventing penetration of water or dirt into the mat. The foam material is tear resistant and sufficiently flexible so that the mat may be rolled into a compact cylindrical tube for compact storage.

The mat may be rectangular, square, triangular, circular, oval or oblong.

An optional odor repellent chemical may be sprayed or embedded into the foam material.

### BRIEF DESCRIPTION OF THE DRAWINGS

FIG. 1 is a top perspective view of a durable dog mat.

FIG. 2 is a bottom perspective view of the dog mat shown in FIG. 1.

FIG. 3 is a top plan view of the dog mat shown in FIGS. 1-2.

FIG. 4 is a bottom plan view of the dog mat shown in FIGS. 1-3.

FIG. 5 is an end elevational view of the dog mat shown in FIGS. 1-4.

FIG. 6 is a side elevational view of the dog mat shown in FIGS. 1-5.

FIG. 7 is a top perspective view of the dog mat in a rolled up storage configuration.

### DESCRIPTION OF THE PREFERRED EMBODIMENT(S)

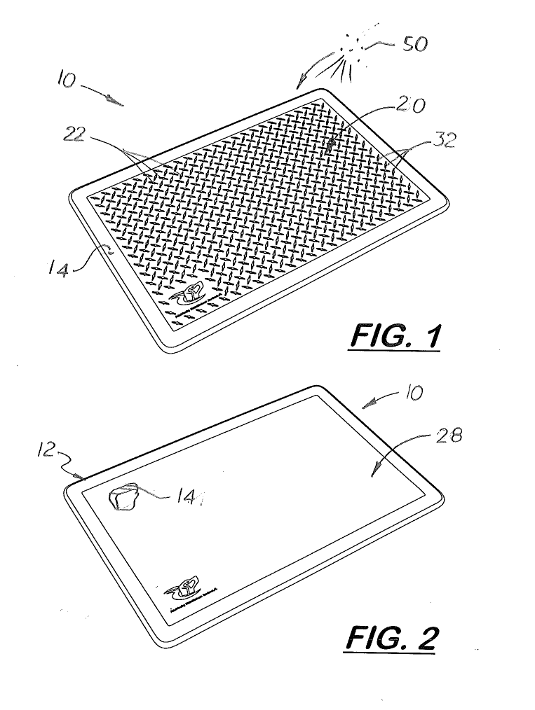

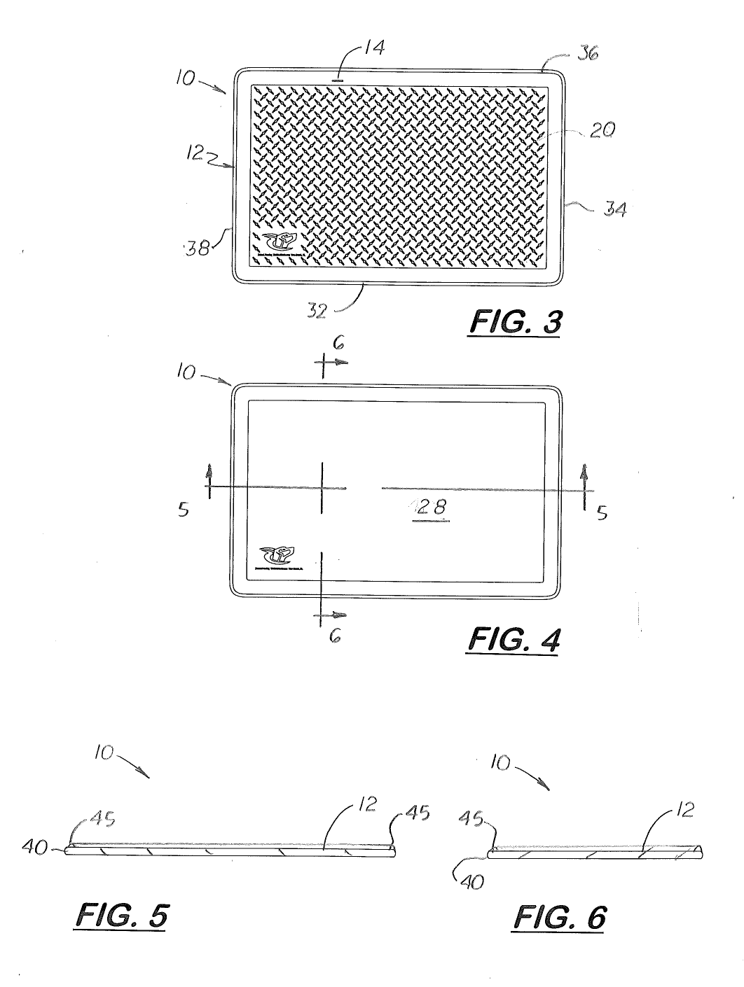

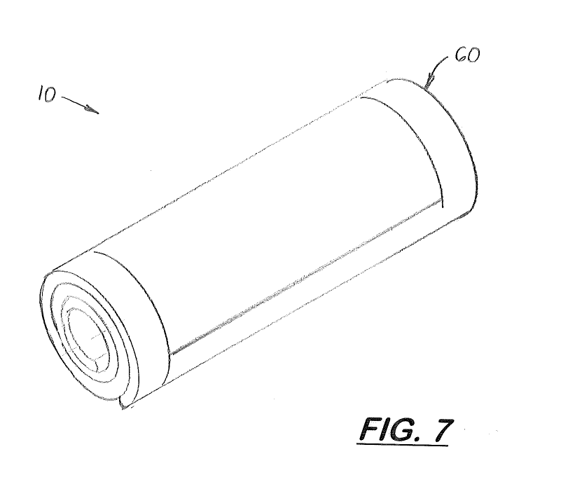

Referring to the accompanying FIGS. 1-7, there is shown a lightweight, durable dog mat 10 made of thin soft foam material impermeable to water, chemicals, pathogens, scratch and tear resistant, and UV resistant. The mat 10 is made of closed cell, cross linked polyolefin elastomeric or ethylene vinyl acetate (EVA) foam with a continuous integrated or self-skinned outer surface 14. The mat 10 is a wide, planar structure designed to be used on the flat surface, such as the floor of a building or home or inside a kennel. The mat 10 includes a first planar surface 20 with texture elements 22, such as a plurality of diamond-shaped raised elements that simulate a metal diamond plate surface, a smooth second surface 28 opposite the first planar surface 20 and four vertical side surfaces 32, 34, 36, and 38. The mat 10 is made by MDI Products LLC, in Sabastian, Fla., using an injection molding process that produces a continuous, thin outer surface 14 impermeable to water, chemicals, and pathogens and is scratch and tear resistant. The outer surface 14 of the mat is UV light and fade resistant.

The foam material is sold under the trademark POLYCELL by MDI Products, Inc. of Sebastian, Fla. (also referred to as ‘flexible foam’). Specific information about the product is available from the company's website at www.mdiproducts.com, and incorporated by reference. In the embodiment shown in the Figs. the mat 10 measures approximately 24 inches in length, 14 inches in width, and ¾ inches think. Formed on the perimeter edge 40 of the mat 10 is an optional raised edge 45 that keeps water puddles formed on the mat 10 from flowing onto the surround floor.

The foam's resiliency/elasticity of 40-45%, the density is 0.16-0.22 g/cm³, the tear strength is 2-3 n/mm², and the harness is 28-65 (Asker C) or 18-70 (Asker A). Compression set is 55% and breakage elongation is 250-280%.

Because the outer surface 14 is impervious to water, water that drips from the dog forms puddles on the mat's surface. Also, because the outer surface 14 is impervious to chemicals, soaps and cleaners may be used on the surface and wiped away. Also, because the outer surface 14 is impervious to pathogens, bacteria, virus, fungus and insects, such as fleas and ticks, do not grow on the surface. Because the outer surface 14 is scratch and tear resistant, the mat 10 is more durable to dog claw marks and resistant to chewing and tearing action.

The mat 10 includes a first planar surface 20 with texture elements 22, such as a plurality of raised diamond shaped elements that simulates a metal diamond plate surface, and second planar surface 30 that is smooth. An odor repellent chemical 50 may be sprayed or embedded into the foam.

During use, the mat 10 may be placed on a flat surface with the first planar surface 20 facing upward and the second planar surface 28 facing downward. Alternatively, the mat 10 may be rotated so the second planar surface 28 is facing upward and the first planar surface 20 is facing downward As shown in FIG. 7, the foam material is sufficiently flexible so that the mat 10 may be rolled into a compact cylindrical tube 60 for compact storage.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. An improved dog mat made of closed cell, cross linked polyolefin elastomeric or ethylene vinyl acetate foam with a continuous thin, soft outer skin impervious to water, chemicals, and pathogens and scratch and tear resistant.

2. The mat as recited in claim 1, further including a planar first layer with raised diamond shaped texture elements.

3. The mat as recited in claim 1, further including an odor repellent chemical.
